(19) United States
(12) Patent Application Publication
(10) Pub. No.: US 2007/0025478 A1
(43) Pub. Date: Feb. 1, 2007

(54) Receiver

(76) Inventor: Shouichi Koga, Iizuka (JP)

Correspondence Address: WENDEROTH, LIND & PONACK L.L.P., 2033 K. STREET, NW, SUITE 800, WASHINGTON, DC, 20006, US

(21) Appl. No.: 10/564,835

(22) PCT Filed: Mar. 8, 2005
(86) PCT No.: PCT/JP05/04412

§ 371 Date: May 16, 2006

(30) Foreign Application Priority Data
Mar. 30, 2004 (JP) 2004-098926

(51) Int. Cl. H04L 27/08; H04L 1/02

(52) U.S. Cl. 375/345; 375/347

(57) ABSTRACT

A receiver including a plurality of receiver branches operable to receive signals, a plurality of sample-and-hold circuits (4), each of which is connected to corresponding one of the receiver branches at the output thereof, a switch (5) connected to the sample-and-hold circuits at outputs thereof, and a demodulating unit (7) connected to the switch (5) at the output thereof. Each of the sample-and-hold circuits (4) is operable to extract a discrete value from the output from corresponding one of the receiver branches. The switch (5) is operable to allow output signals from the sample-and-hold circuits (4) to be selectively fed out of the swit

### TECHNICAL FIELD

The present invention relates to a receiver operable to demodulate a plurality of receiver signals. More particular, it relates to a receiver adapted for the demodulation based on downsampling-based frequency conversion.

### BACKGROUND ART

A recent increase in communication capacity draws attention to a multi-antenna art designed to provide a receiver having several antennas disposed thereon.

In applications of the multi-antenna art, it has been proposed to use spatial multiplexing communication arts such as MIMO (Multiple Input Multiple Output) based on spatially disposed antennas. The MIMO is operable to allow different signals at the same band, received by the several antennas, to be simultaneously demodulated, thereby providing an increased communication capacity.

In another application of the multi-antenna art, diversity is provided to improve transmission quality. For example, according to selection diversity as an example of the diversity, the several antennas are used to receive signals in order to select therefrom a receiver signal received by a high-receptive antenna, thereby demodulating the selected signal.

In the receivers as previously mentioned, high-frequency radio signals at such as gigahertz (GHz) bands must be converted to intermediate frequency signals in order to process the signals at electronic circuits.

Cited reference No. 1 (published Japanese Patent Application Laid-Open No. (HEI) 9-284191) discloses a multi-antenna receiver designed to convert the high-frequency signals to the intermediate frequency signals using mixers in several receiver branches to demodulate the signals.

FIG. 15 is a block diagram illustrating a prior art receiver as disclosed in cited reference No. 1.

Each of the receiver branches includes a separate circuit such as the mixer for converting the high-frequency signal to the intermediate frequency signal.

Cited reference No. 2 (published Japanese Patent Application Laid-Open No. 2001-111465) discloses a downsampling-based receiver having several antennas disposed thereon.

Sampling below the Nyquist frequency produces aliasing elements at low-frequency bands. The downsampling extracts the aliasing elements without the use of analog frequency converters such as the mixers, whereby equivalent conversion in frequency is achievable.

FIG. 16 is a block diagram illustrating a prior art receiver as disclosed in cited reference No. 2. The receiver includes several (three in FIG. 16) receiver branches 219.

Each of the receiver branches 219 includes an antenna 211, a band pass filter 212, and a low noise amplifier 213. A switch 214 is connected to each of the receiver branches 219 at the output thereof to select the output from any one of the receiver branches 219. The switch 214 is connected at the output thereof to a sample-and-hold circuit 215. The sample-and-hold circuit 215 is operable to frequency-convert receiver signals received thereby. An analog-to-digital converter 216 is operable to convert the frequency-converted signals in value from analog values into digital values. The signals having the converted digital values are demodulated by a demodulating unit 217, in which data is extracted from the demodulated signals.

However, the prior art receiver as disclosed in cited reference No. 1 has problems of larger-sized circuits and increased power consumption because more receiver branches result in more circuits such as the mixers including multipliers.

A problem with the prior art receiver as disclosed in cited reference No. 2 is that the high-frequency signals enter the switch 214, thereby causing insufficient isolation in the switch 214. More specifically, the problem is that the high-frequency signals or the outputs from the receiver branches 219 enter the switch 214, in which non-connected signals escape to connected routes in a propagated manner. The signal leak in the switch 214 is particularly troublesome because the high-frequency signals have values rapidly varied. The signal leak in the switch 214 destroys signal waveforms, and brings about errors in the demodulating unit 217.

Another problem with the prior art receiver as disclosed in reference No. 2 is that a difference in wiring length for each of the several receiver branches is likely to vary the phase of each waveform that reaches the switch 214 when the high-frequency signals enter the switch 214. The wiring length difference-caused variations in phase increase with an increase in frequency.

A further problem with the prior art receiver as disclosed in reference No. 2 is that the amplitudes of the signals to be fed into the analog-to-digital converter 216 are likely to considerably vary between the receiving braches 219 because the single analog-to-digital converter 216 is shared by the several receiver branches 219. A still further problem is that the different signal amplitudes exceed a dynamic range of the analog-to-digital converter 216, thereby producing noises.

### DISCLOSURE OF THE INVENTION

In view of the above, an object of the present invention is to provide a smaller-scaled circuit-containing receiver operable to receive receiver signals with good accuracy, which otherwise would be degraded because of signal leak in a switch and/or variations in signal phase in the switch, and operable to simultaneously process the receiver signals received by several receiver branches.

A first aspect of the present invention provides a receiver including a plurality of receiver branches operable to receive signals, a plurality of sample-and-hold circuits, each of which is connected to corresponding one of the plurality of receiver branches thereof, a switch connected to the plurality of sample-and-hold circuits thereof, and a demodulating unit connected to the switch thereof. Each of the sample-and-hold circuits is operable to extract a discrete value from the output from corresponding one of the receiver branches. The switch is operable to allow output signals from the sample-and-hold circuits to be selectively fed out of the switch at time intervals. The demodulating unit is operable to demodulate data from output signals from the switch.

The above structure allows low-frequency signals, not high-frequency signals to be fed into the switch, thereby preventing the occurrence of signal leak in the switch.

A second aspect of the present invention provides a receiver in which each of the receiver branches includes a band pass filter operable to allow corresponding one of the signals to travel through a certain band, and a first amplifier operable to amplify the output from the band pass filter.

The above structure allows a required band to be controlled in each of the receiver branches, thereby providing each signal having a level sufficient for the demodulation.

A third aspect of the present invention provides a receiver in which each of the receiver branches includes an antenna.

The above structure realizes a receiver operable to provide wireless communication

A fourth aspect of the present invention provides a receiver further including an analog-to-digital converter connected between the switch at the output thereof and the demodulating unit. The analog-to-digital converter is operable to convert the output signals from the switch in value from analog values to digital values.

The above structure allows a digital communication receiver to provide digital signal-based demodulation.

A fifth aspect of the present invention provides a receiver further including a clock-generating unit operable to generate clock signals to be fed into the plurality of sample-and-hold circuits, the switch, and the analog-to-digital converter.

The above structure generates a clock required for both of the downsampling and demodulating of the signals received by the several receiver branches. In addition, the generated clock allows the downsampling and demodulation to be carried out in synchronism with one another.

A sixth aspect of the present invention provides a receiver further including an amplifier connected to the clock-generating unit thereof. The amplifier is operable to amplify the clock signals from the clock-generating unit by an integer multiple comparable in number to the plurality of receiver branches. In the receiver, the output from the amplifier is fed into the switch and the analog-to-digital converter.

The above structure allows the receiver signals received by all of the receiver branches to be demodulated in accordance with the number of the receiver branches.

A seventh aspect of the present invention provides a receiver further including a second amplifier connected to the analog-to-digital converter at the input thereof, a gain control unit operable to control a gain in the second amplifier, and a gain control information-detecting unit operable to detect gain control information to be fed into the gain control unit.

The above structure permits the analog-to-digital converter to receive each signal having a level that optimally meets a dynamic range of the analog-to-digital converter. As a result, there is a reduced likelihood of errors in quantization and the like in the analog-to-digital converter.

An eighth aspect of the present invention provides a receiver in which the gain control information is a signal-to-noise ratio (hereinafter called an “S/N ratio”) detected by the demodulating unit.

The above structure detects an optimum gain to be used as the reference of signal amplification. In addition, a difference in receptive level between the receiver branches is taken into account, and any signal having the maximum level is allowed to fall within the dynamic range of the analog-to-digital converter.

A ninth aspect of the present invention provides a receiver in which the gain control information is a bit error rate (hereinafter called a “BER”) detected by the demodulating unit.

The above structure detects an optimum gain to be used as the reference of signal amplification. In addition, a difference in receptive level between the receiver branches is taken into account, and any signal having the maximum level is allowed to fall within the dynamic range of the analog-to-digital converter.

A tenth aspect of the present invention provides a receiver in which the second amplifier has an amplification degree falling within a dynamic range of the analog-to-digital converter.

As a result, the amplified signals to be fed into the analog-to-digital converter fall within the dynamic range of the analog-to-digital converter.

An eleventh aspect of the present invention provides a receiver further including a plurality of third amplifiers, each of which is connected to corresponding one of the plurality of sample-and-hold circuits thereof, a gain control unit operable to control gains in the plurality of third amplifiers, and a gain control information-detecting unit operable to detect gain control information to be fed into the gain control unit. Each of the third amplifiers is operable to amplify the output from corresponding one of the sample-and-hold circuits.

The above structure allows the analog-to-digital converter to receive each signal having a level that optimally meets the dynamic range of the analog-to-digital converter. As a result, there is a reduced likelihood of errors in quantization and the like in the analog-to-digital converter.

A twelfth aspect of the present invention provides a receiver in which each of the plurality of third amplifiers has a substantially identical gain characteristic.

The above structure allows the output signal from each of the receiver branches to be amplified at the same ratio. As a result, demodulation with uniform accuracy is achievable for each of the receiver branches.

A thirteenth aspect of the present invention provides a receiver in which each of the plurality of third amplifiers has an amplification degree, whereby the highest gain possessed by one of output signals from the plurality of sample-and-hold circuits to be amplified by the plurality of third amplifiers falls within a dynamic range of the analog-to-digital converter.

As a result, the amplified signals to be fed into the analog-to-digital converter fall within the dynamic range of the analog-to-digital converter.

A fourteenth aspect of the present invention provides a receiver further including a clock control unit operable to control a clock frequency in the clock-generating unit.

The above structure provides a lower clock frequency in accordance with a state of each of the receiver signals, and the receiver consumes less power.

A fifteenth aspect of the present invention provides a receiver in which the clock control unit is operable to divide the clock frequency in the clock-generating unit in accordance with the number of frequency division multiplex signals in operative use when the signals received by the plurality of receiver branches include the frequency multiplex signals.

The above structure provides a sampling clock having a lower frequency to each of the sample-and-hold circuits in accordance with unwanted channels. Such a reduction in sampling clock frequency reduces power consumption.

A sixteenth aspect of the present invention provides a receiver in which a length of wiring extending from the input end of each of the plurality of receiver branches to each of the sample-and-hold circuits is substantially identical for each of the plurality of receiver branches.

The above structure prevents, for each of the receiver branches, the occurrence of variations in phase between high-frequency signals to be transmitted to each of the sample-and-hold circuits, and consequently provides demodulation with improved accuracy.

A seventeenth aspect of the present invention provides a receiver in which a load on wiring extending from the input end of each of the plurality of receiver branches to each of the sample-and-hold circuits is substantially identical for each of the plurality of receiver branches.

The above structure prevents, for each of the receiver branches, the occurrence of variations in phase between high-frequency signals to be transmitted to each of the sample-and-hold circuits, and consequently provides demodulation with improved accuracy.

An eighteenth aspect of the present invention provides a receiver including a plurality of receiver branches operable to receive signals, a switch connected to the plurality of receiver branches thereof, a sample-and-hold circuit connected to the switch thereof, a variable amplifier connected to the sample-and-hold circuit thereof, a gain control unit operable to control a gain in the variable amplifier, a gain control information-detecting unit operable to detect gain control information to be fed into the gain control unit, an analog-to-digital converter connected to the variable amplifier thereof, and a demodulating unit connected to the analog-to-digital converter thereof. The switch is operable to allow output signals from the plurality of receiver branches to be selectively fed out of the switch at time intervals. The sample-and-hold circuit is operable to extract discrete values from output signals from the switch. The variable amplifier is operable to amplify output signals from the sample-and-hold circuit. The analog-to-digital converter is operable to convert output signals from the variable amplifier in value from analog values to digital values. The demodulating unit is operable to demodulate data from output signals from the analog-to-digital converter. In the receiver, the gain control unit executes control such that the output signals from the variable amplifier fall within a dynamic range of the analog-to-digital converter.

The above structure allows the analog-to-digital converter to receive each signal having a level that optimally meets the dynamic range of the analog-to-digital converter. As a result, there is a reduced likelihood of errors in quantization and the like in the analog-to-digital converter.

A nineteenth aspect of the present invention provides a receiver including a plurality of receiver branches operable to receive signals, a switch connected to the plurality of receiver branches thereof, a sample-and-hold circuit connected to the switch thereof, an analog-to-digital converter connected to the sample-and-hold circuit thereof, a demodulating unit connected to the analog-to-digital converter thereof, a clock-generating unit operable to generate clock signals to be fed into the switch, the sample-and-hold circuit, and the analog-to-digital converter, and a clock control unit operable to control a clock frequency in the clock-generating unit. The switch is operable to allow output signals from the plurality of receiver branches to be selectively fed out of the switch at time intervals. The sample-and-hold circuit is operable to extract discrete values from output signals from the switch. The analog-to-digital converter is operable to convert output signals from the sample-and-hold circuit in value from analog values to digital values. The demodulating unit is operable to demodulate data from output signals from the analog-to-digital converter.

The above structure provides a lower clock frequency in accordance with a state of each of the receiver signals, and the receiver consumes less power.

### BRIEF DESCRIPTION OF THE DRAWINGS

FIG. 1 is a block diagram illustrating a receiver according to a first embodiment of the present invention;

FIG. 2 is an illustration showing operational waveforms from each sample-and-hold circuit according to the first embodiment;

FIG. 3 is a block diagram illustrating each of the sample-and-hold circuits according to the first embodiment;

FIG. 4 is an illustrating showing waveforms of signals fed from each of the sample-and-hold circuits to the switch at the output thereof;

FIG. 5(a) is an illustration showing a frequency characteristic of each receiver signal according to the first embodiment;

FIG. 5(b) is an illustration showing a frequency characteristic of each of the downsampled signals according to the first embodiment;

FIG. 5(c) is an illustration showing a frequency characteristic of each of the downsampled signals according to the first embodiment;

FIG. 6(a) is an illustration showing a frequency characteristic of each receiver signal according to the first embodiment;

FIG. 6(b) is an illustration showing a frequency characteristic of each of the downsampled signals according to the first embodiment;

FIG. 6(c) is an illustration showing a frequency characteristic of each of the downsampled signals according to the first embodiment;

FIG. 7 is a block diagram illustrating a receiver according to a second embodiment;

FIG. 8(a) is a block diagram illustrating each sample-and-hold circuit according to the second embodiment;

FIG. 8(b) is a block diagram illustrating each of the sample-and-hold circuits according to the second embodiment;

FIG. 9(a) is an illustration showing waveforms of output signals from receiver branches according to the second embodiment;

FIG. 9(b) is an illustration showing waveforms of amplified output signals from the receiver branches according to the second embodiment;

FIG. 10 is a block diagram illustrating a receiver according to the second embodiment;

FIG. 11 is a block diagram illustrating a receiver according to a third embodiment;

FIG. 12 is an illustration showing a frequency characteristic of each receiver signal according the third embodiment;

FIG. 13 is a block diagram illustrating a receiver according to a fourth embodiment;

FIG. 14 is a block diagram illustrating a receiver according to the fourth embodiment;

FIG. 15 is a block diagram illustrating a prior art receiver; and

FIG. 16 is a block diagram illustrating a prior art receiver.

### BEST MODE FOR CARRYING OUT THE INVENTION

Embodiments of the present invention are now described with reference to the accompanying drawings.

In the present description, a low noise amplifier, a variable amplifier connected to an analog-to-digital converter at the input thereof, and an amplifier in each sample-and-hold circuit are a first amplifier, a second amplifier, and a third amplifier, respectively.

### First Embodiment

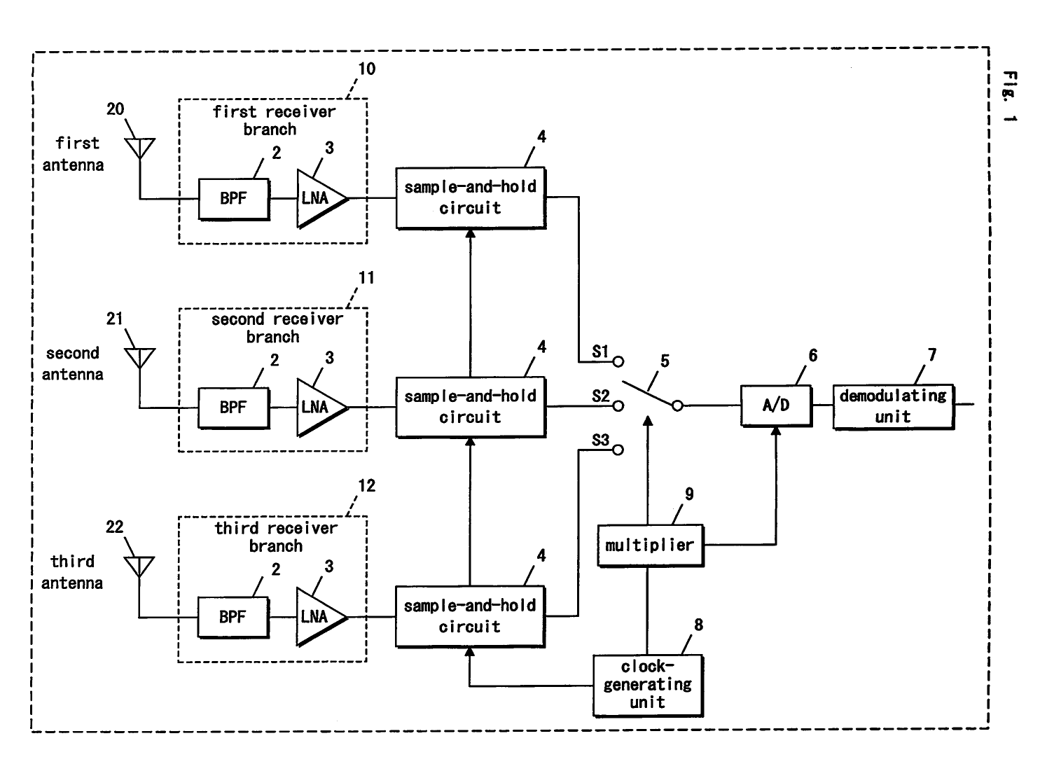

A receiver according to a first embodiment is now described with reference to FIG. 1 to FIG. 6. The present embodiment is described based on the premise of three receiver branches.

FIG. 1 is a block diagram illustrating the receiver according to the present embodiment.

The receiver includes elements as given below. There are provided three different receiver branches, i.e., first, second, and third receiver branches 10, 11, 12; and first, second, and third antennas 20, 21, 22, each of which is connected to a corresponding one of the receiver branches. A sample-and-hold circuit 4 is connected to each of the receiver branches. The sample-and-hold circuits 4 are connected at the outputs thereof to a switch 5. The switch 5 is connected at the output thereof to an analog-to-digital converter 6. The analog-to-digital converter 6 is connected at the output thereof to a demodulating unit 7. A clock-generating unit 8 feeds clock signals into the sample-and-hold circuits 4, the switch 5, and the analog-to-digital converter 6. A multiplier 9 is provided at the output of the clock-generating unit 8.

The following discusses details of the above elements, and how they are operated.

The receiver branches and the antennas connected thereto are now described.

The first, second, and third antennas 20, 21, 22 are located at different spatial positions. The antennas are operable to receive radio signals. Alternatively, cables may be used to receive line signals instead of the use of the antennas to receive the radio signals. Each of the antennas feeds an output signal into corresponding one of the receiver branches connected to the antennas.

Each of the first, second, and third receiver branches 10, 11, 12 includes a band pass filter (hereinafter called a “BPF”) 2 and a low noise amplifier (hereinafter called a “LNA”) 3. Each of the BPFs 2 is operable to extract a required band from the signal received by corresponding one of the antennas. Each of the LANs 3 is operable to amplify the receiver signal received by corresponding one of the antennas.

It is preferred that a low pass filter (hereinafter called a “LPF”) operable to eliminate noises from the signals is connected to each of the BPFs at either the front or rear thereof. Assuming that the receiver has a transmission capability, each of the first, second, and third antennas 20, 21, 22 may include an antenna switch that permits corresponding one of the antennas to switch over between transmitting and receiving functions.

The sample-and-hold circuits 4 are now described.

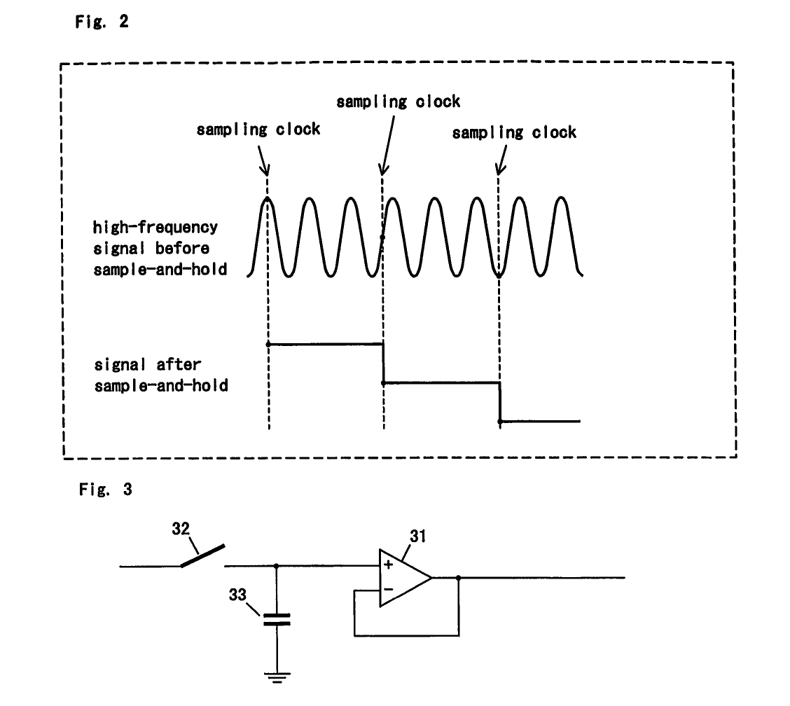

Each of the sample-and-hold circuits 4 is operable to extract a discrete value from corresponding one of the receiver signals (i.e., high-frequency signals) in response to fixed sampling clock signals. FIG. 2 is an illustration showing operational waveforms of each of the sample-and-hold circuits according to the present embodiment. The upper one of the waveforms is of a high-frequency signal fed into each of the sample-and-hold circuits 4. The lower one of the waveforms is of a signal indicative of a discrete value from each of the sampled-and-held high-frequency signals.

The discrete value is extracted, in response to the sampling clock signals, from the high-frequency signal fed into each of the sample-and-hold circuits 4. The extraction of the discrete value from the high-frequency signal converts the high-frequency receiver signal into a low-frequency receiver signal.

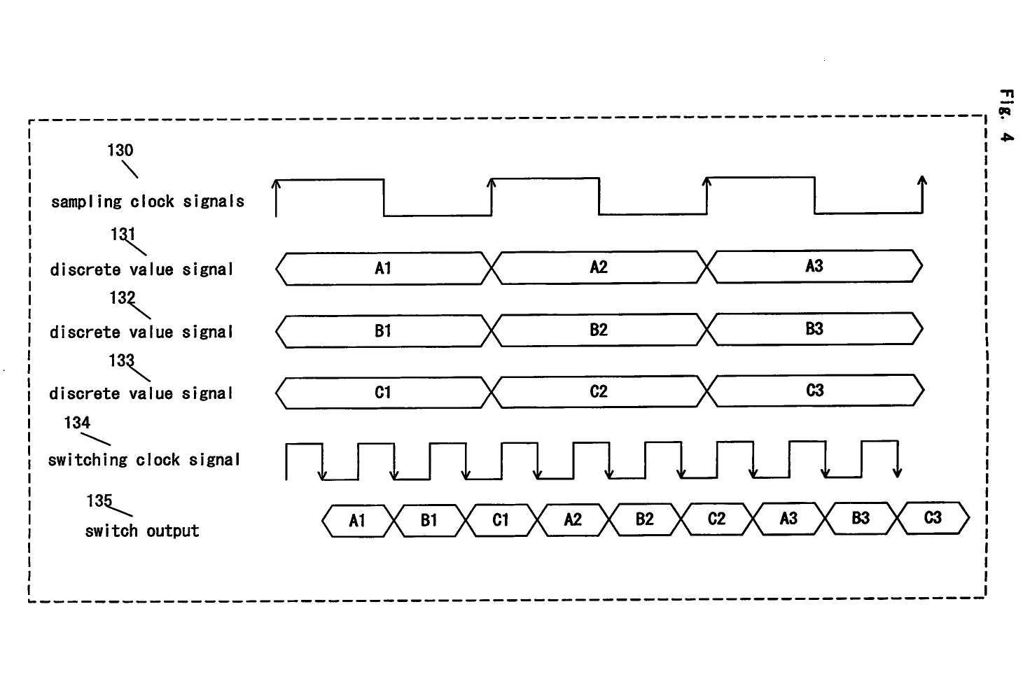

FIG. 3 is a block diagram illustrating each of the sample-and-hold circuits according to the present embodiment. A capacitor 33 and a switch 32 are connected to a voltage follower at the input thereof. The voltage follower employs an operational amplifier 31. The switch 32 is operable to change over between on and off in response to the sampling clock signals. An instantaneous value of the input signal at the moment when the switch 32 is turned off is fed into the capacitor, in which the instantaneous value is retained as a discrete value. As a result, as illustrated in FIG. 2, the low-frequency discrete value is extracted from the high-frequency analog signal.

The switch 5, clock-generating unit 8, and multiplier 9 are now described.

The output from each of the sample-and-hold circuits 4 enters the switch 5. The switch 5 is operable to sequentially switch over between the receiver branches in response to clock signals. The clock signals correspond in number with the receiver branches. As a result, corresponding one of the receiver branches is connected to the switch 5. Referring to FIG. 1, the connection is shown changed in order of S1, S2, S3, and S1. Since the number of the receiver branches according to the present embodiment is three, the multiplier 9 allows the clock-generating unit 8 to send out three times greater output clock signals to the switch 5.

The clock-generating unit 8 may be a clock transmitter, or alternatively may be another clock transmitter used on other circuits.

Next, a flow of different signals from each of the sample-and-hold circuits 4 to the output from the switch 5 is described with reference to FIG. 4.

FIG. 4 illustrates waveforms of the signals from the sample-and-hold circuits 4 to the switch 5 at the output thereof.

The present description assumes that the sampling clock signals are clock signals to be fed into the sample-and-hold circuits.

Sampling clock signals 130 enter the sample-and-hold circuits 4. Each of the sample-and-hold circuits 4 extracts a discrete value, in accordance with the sampling clock signals 130, from the signal received by corresponding one of the receiver branches. A discrete value signal 131 is a discrete value signal received by the first receiver branch 10 and extracted by corresponding one of the sample-and-hold circuits 4. Signals A1, A2, and A3 are illustrated as the discrete value signal 131.

Similarly, a discrete value signal 132 is a discrete value signal received by the second receiver branch 11 and extracted by corresponding one of the sample-and-hold circuits 4. The discrete value signal 132 includes signals B1, B2, B3. A discrete value signal 133 is a discrete value signal received by the third receiver branch 12 and extracted by corresponding one of the sample-and-hold circuits 4. The discrete value signal 33 includes signals C1, C2, C3.

The signals A1, A2, A3, B1, B2, B3, C1, C2, and C3 are multi-valued signals.

The multiplier 9 allows switching clock signals 134 to travel three times as fast as the sampling clock signals 130. The switch 5 is switched over in accordance with each trailing edge of the switching clock signals 134. As a result, the discrete value signals are sequentially fed out of the switch 5 in order of A1, B1, C1, A2 etc.

Thus, all of the signals received by the three receiver branches are processed in chronological order. This means that the signals received by the several antennas are all processed.

The analog-to-digital converter 6 is now described.

The output signals from the switch 5 enter the analog-to-digital converter 6.

The analog-to-digital converter 6 converts the output signals from the switch 5 in value from analog values to digital values. For example, an analog-digital converter may be used. The number of quantized bits is determined in accordance with the specification of the receiver. The analog-to-digital converter 6 must be used to process digital signals in the demodulating unit 7, but need not be used to process analog signals in the demodulating unit 7.

The demodulating unit 7 is now described.

The output signals from the analog-to-digital converter 6 are fed into the demodulating unit 7, although the output signals from the switch 5 are fed into the demodulating unit 7 to process the analog signals in the demodulating unit 7. The demodulating unit 7 executes orthogonal detection to extract data from the signals, thereby detecting and/or correcting errors when necessary. The demodulating unit 7 may be, e.g., a DSP (Digital Signal Processor), or alternatively may be a dedicated circuit such as an ASIC (Application Specific Integrated Circuit).

As illustrated in FIG. 4, the receiver signals received by all of the receiver branches are sequentially fed into the demodulating unit 7, and consequently a greater number of data can be processed, when compared with the use of a single receiver branch.

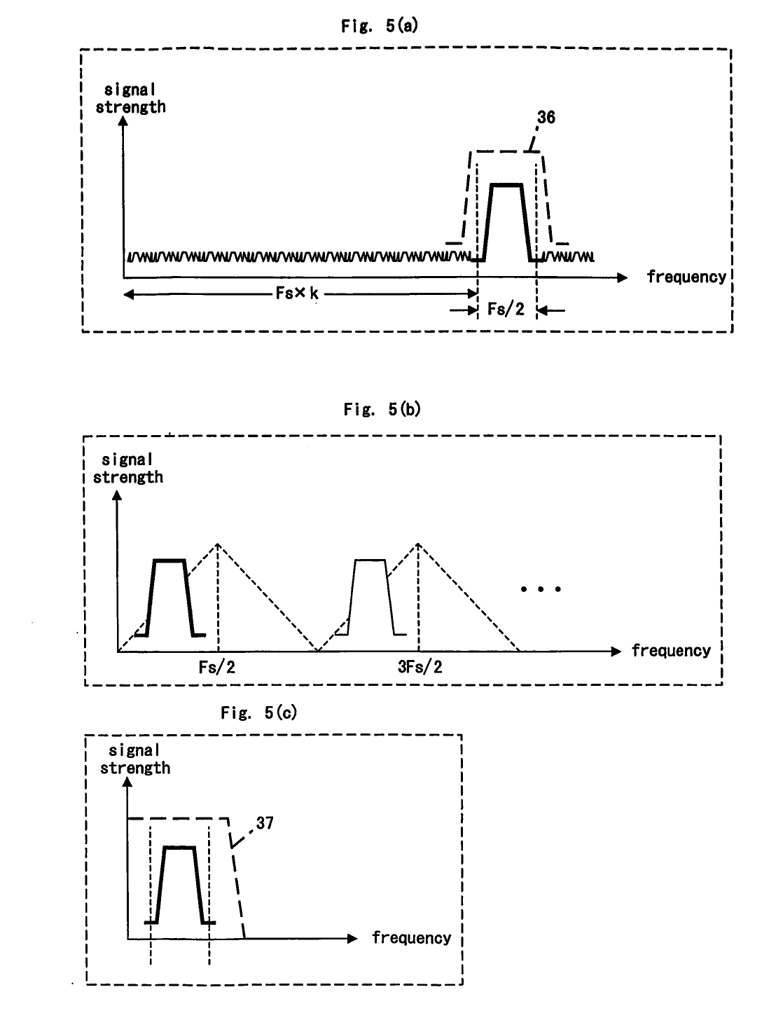

FIG. 5 illustrates a process in which a received signal is converted in frequency band from a high-frequency radio frequency band to a low-frequency base band pass.

FIG. 5(a) illustrates a relationship between the receiver signal's radio frequency band and sampling clock frequency “Fs” fed into each of the sample-and-hold circuits 4. The BPF limits the receiver signal's band to Fs/2. More specifically, the receiver signal is limited to a BPF pass band 36. Pursuant to the present embodiment, the frequency “Fs” is determined in such a manner that a lower limit frequency for each radio signal is a result from “Fs” multiplied by “k” (“k” is an integer).

As illustrated in FIG. 5(b), the processing in each of the sample-and-hold circuits 4 produces aliasing elements that include center frequencies Fs/2, 3Fs/2, etc. Each of the aliasing elements is filtered to extract a demodulating band 37 therefrom.

The demodulating band 37 is a signal as illustrated in FIG. 5(c). As a result, the received signals are converted in frequency band to the base band pass.

According to the MIMO art, the antennas are preferably spaced apart from each other by a distance equal to wavelength spacing, so as to provide reduced correlation characteristics between the antennas. According to the array antenna art, to prevent grating lobes, it is preferred that antennas are usually arranged at evenly spaced intervals, each of which is equal to a half of a wavelength.

It is preferred that at least one of a wiring length and a wiring load is substantially the same for each of the receiver branches, in which the wiring extends between the input end of each of the receiver branches and each of the sample-and-hold circuits 4.

The substantially same wiring length and/or wiring load prevent variations in phase of the signal fed into each of the sample-and-hold circuits 4, and the signals are received with improved accuracy. The signal phase variation-free receiver avoids being adversely affected by switching noise.

The substantially same wiring length and/or wiring load for each of the receiver branches may alternatively be realized by substantially the same layout.

Assuming that the signals received by the receiver branches are multi-channel signals multiplexed on the frequency scale, the receiver according to the present invention is operable to convert each of the multi-channel signals in frequency to a base band frequency, thereby demodulating the converted signals.

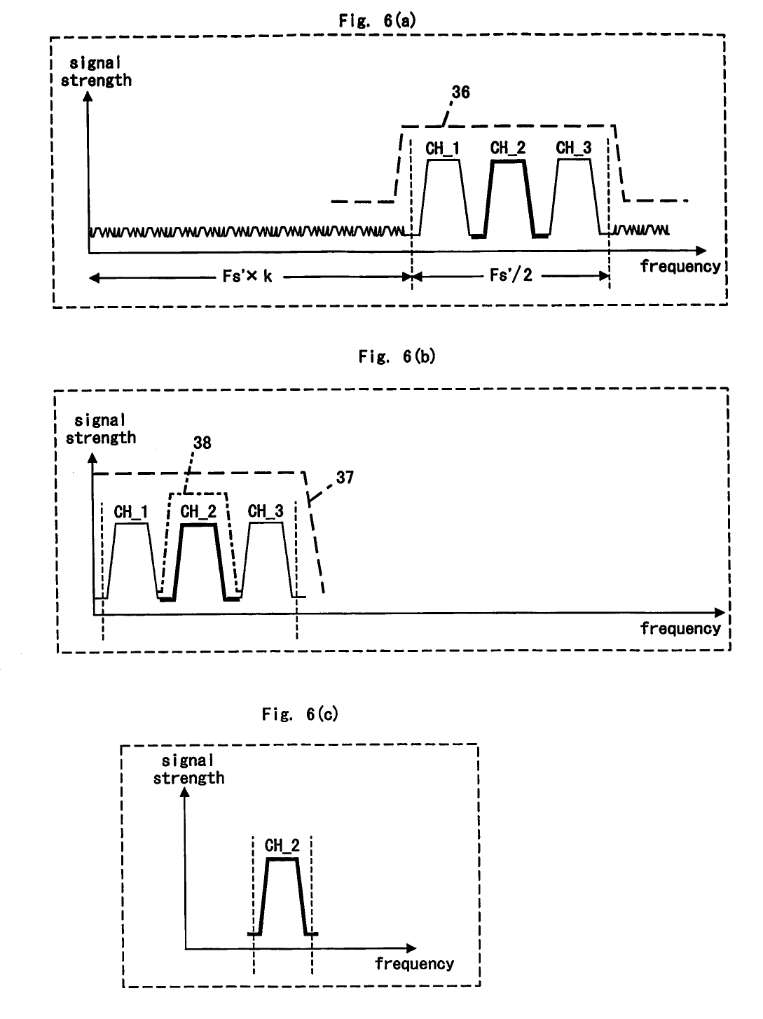

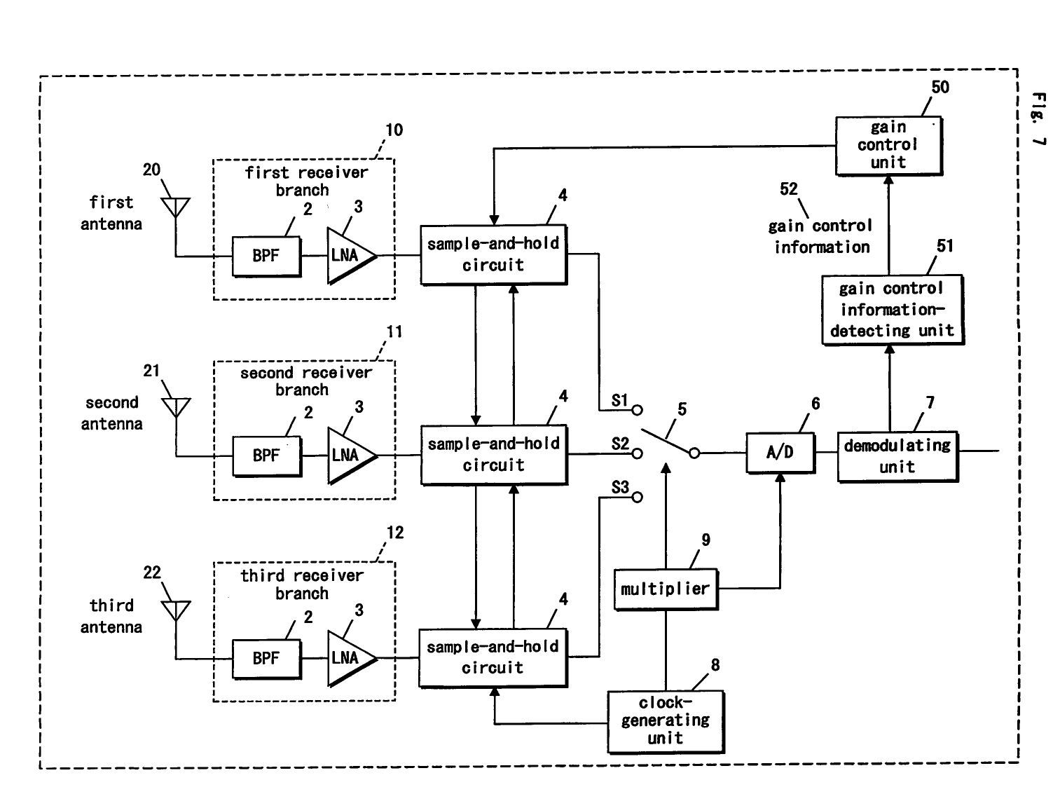

FIG. 6 is illustrations showing a signal waveform according to the present embodiment. The BPF pass band 36 includes three channels, i.e., a CH_1, CH_2, and CH_3. For example, the use of frequency division multiplex suited for several users allows the BPF pass band 36 to contain several channels.

Even when the BPF pass band 36 contains several carriers as previously discussed, each of the sample-and-hold circuits 4 converts the signal in frequency band from the high-frequency band to the low-frequency base band pass. As illustrated in FIG. 6(b), the BPF pass band 36 is converted to the demodulating band 37 in which the three channels (CH_1, CH_2, and CH_3) remain contained.

Assuming that only one of the three channels is in use for communication, a selection filter is used to extract a band from the demodulating band 37. A selection filter pass band 38 is extracted from the demodulating band 37 using the selection filter, thereby extracting only the channel CH_2 to demodulate the signal.

Assuming that only CH_2 is in use, the sampling clock signals are rendered as Fs'/3, thereby extracting only CH_2 from the demodulating band 37. The reduced sampling clock signals result in reduced power consumption. According to the present embodiment, the sampling clock signals are reduced in frequency to one third, and the power consumption is reduced to one third as well.

As described above, the receiver having each of the sample-and-hold circuits 4 connected to corresponding one of the receiver branches feeds the low-frequency signals, not the high-frequency signals, into the switch 5. As a result, neither signal leak nor signal propagation occurs in the switch 5, and the signals are received with improved accuracy.

The receiver has fewer constraints on design to set up switch isolation, and is available at reduced cost.

The receiver is possible to simultaneously treat the receiver signals received by the several antennas disposed thereon, and consequently provides high-capacity communication while receiving the signals with higher accuracy.

Although the present embodiment has been described based on the premise of the “three” receiver branches, a greater or smaller number of receiver branches may be used as an alternative. In addition, receivers operable to receive line signals provide advantages similar to those according to the receiver operable to receive the radio signals.

The receiver according to the present embodiment is applicable to diversity receivers.

The receiver according to the present embodiment is applicable to wireless and cable communication apparatus in wireless LAN, home servers, and base stations.

### Second Embodiment

A second embodiment is directed to a receiver operable to provide an optimized dynamic range of an analog-to-digital converter.

FIG. 7 is a block diagram illustrating the receiver according to the present embodiment.

The receiver is substantially the same as that of FIG. 1 according to the previous embodiment, but includes additional elements, i.e., a gain control unit 50 and a gain control information-detecting unit 51.

An analog-to-digital converter has a dynamic range at which input signals are permissible. The conversion of the signals within the dynamic range provides minimized quantization noises. Accordingly, the signals fed into the analog-to-digital converter 6 are preferably amplified up to the dynamic range.

In receivers operable to simultaneously process signals received by several receiver branches, it is preferred that the signals are processed equally in the receiver branches because the signals must be demodulated based on original levels of the signals. More specifically, the signal in each of the receiver branches is preferably amplified based on an equal gain.

An internal circuit in each sample-and-hold circuit 4 is used to amplify the signal to be fed into the analog-to-digital converter 6.

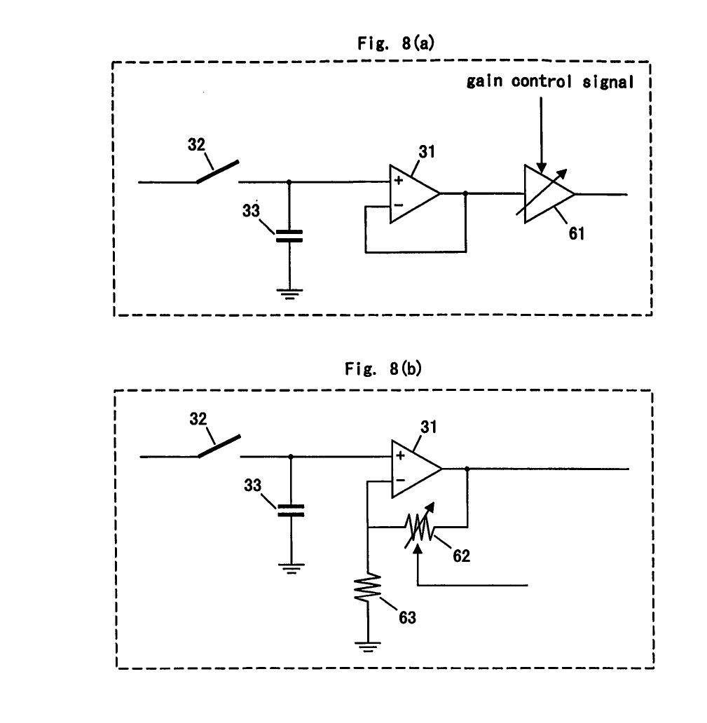

Each of FIGS. 8(a) and 8(b) is a block diagram illustrating the interior of each of the sample-and-hold circuits 4.

An amplifier 61 in each of the sample-and-hold circuits 4 is used to amplify the signal.

The amplifier 61 is gain-controlled in accordance with a control signal from the gain control unit 50. Although all of the receiver branches include the amplifiers 61, the amplifiers 61 preferably provide equal gains.

A variable resistance 62 in each of the sample-and-hold circuits 4 is used to amplify the signal. The variable resistance 62 is connected in parallel to an operational amplifier 31 in each of the sample-and-hold circuits 4, but is connected in series to a terminating resistance 63, whereby variations in resistance value vary the output in level from the operational amplifier 31. Similarly to the amplifier 61, a resistance value in the variable resistance 62 is controlled by the control signal from the gain control unit 50.

The signal amplification as described above allows output signals to be fed from the receiver branches at equally increased levels. At this time, an output signal having the maximum level from each of the receiver branches is preferably gain-controlled to meet the dynamic range of the analog-to-digital converter 6. More specifically, gains are equally controlled in all of the receiver branches in such a manner that the output having the maximum level from each of the receiver branches falls within the dynamic range of the analog-to-digital converter 6.

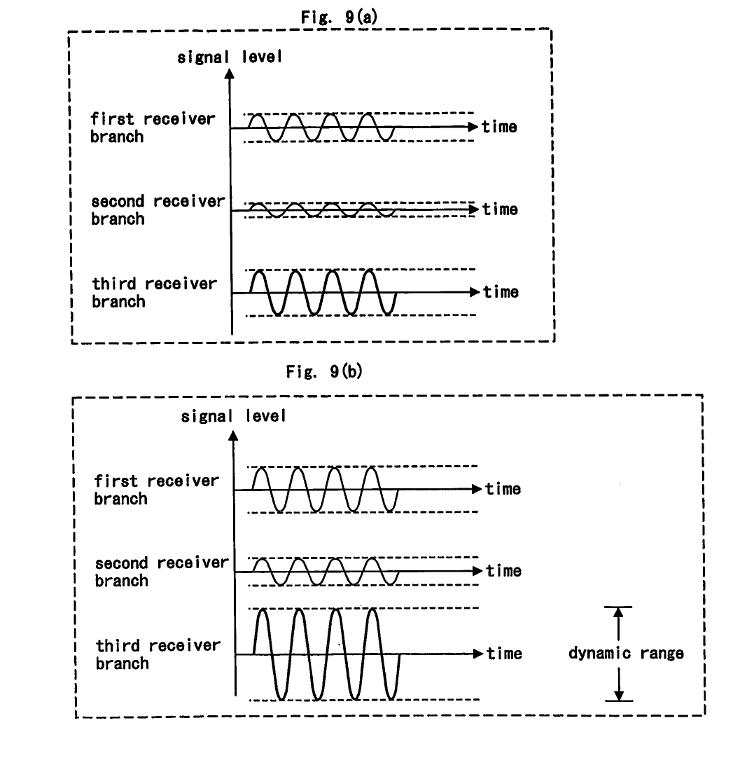

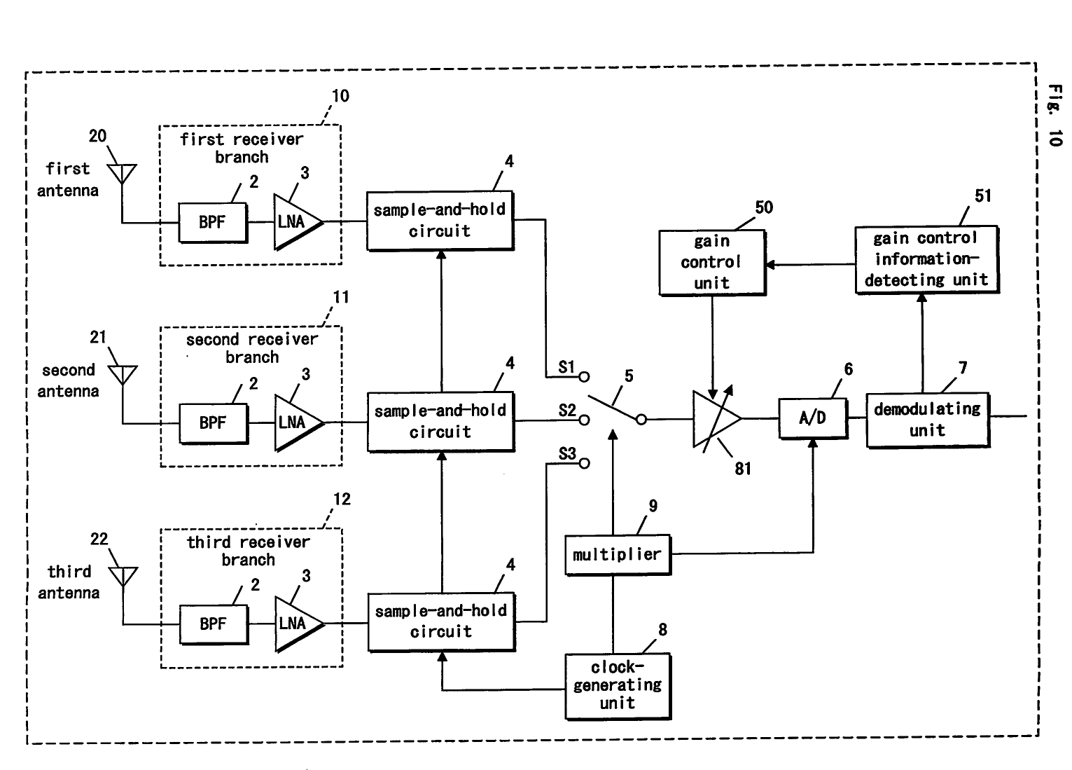

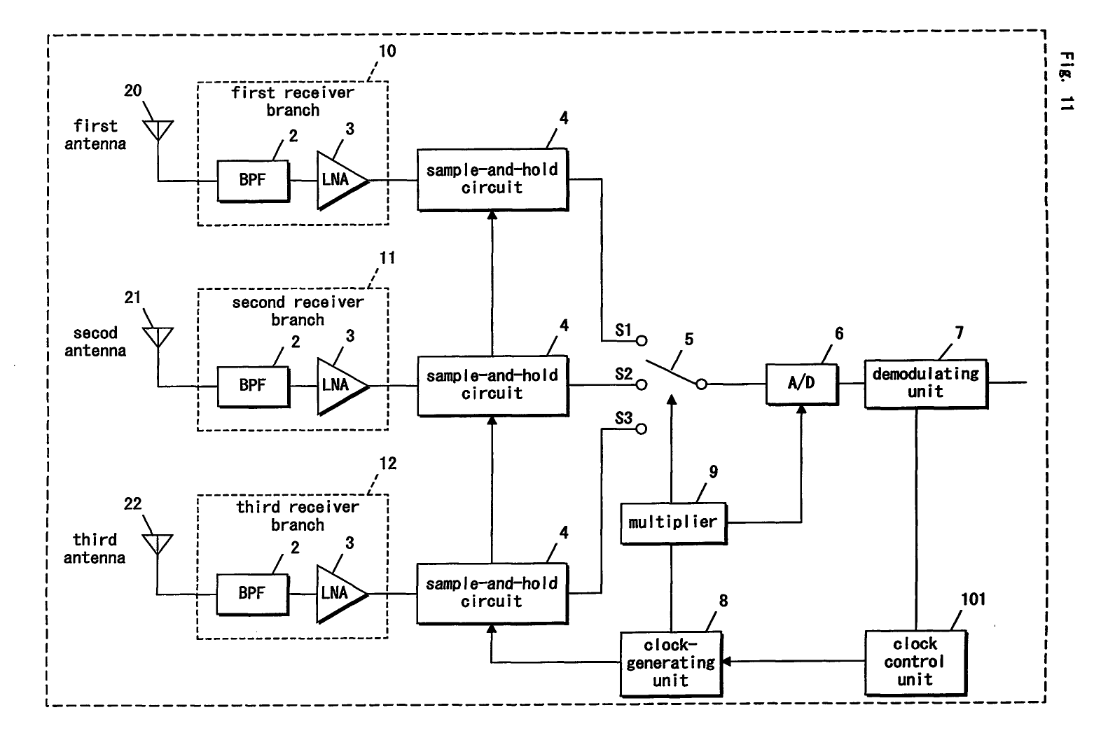

FIG. 9(a) is an illustration showing waveforms of the output signals from the receiver branches according to the present embodiment. FIG. 9(b) is an illustration showing waveforms of the amplified output signals from the receiver branches according to the present embodiment. The output signals from the receiver branches are amplified in accordance with the equal gains, and any one of the output signals, which has the maximum level, remains falling within the dynamic range of the analog-to-digital converter.

The following discusses the gain control unit 50, gain control information-detecting unit 51, and gain control information 52.

The gain control unit 50 has control of a gain degree in the amplifier 61 and a resistance value in the variable resistance 62. The gain control information 52 is required to execute the control by the gain control unit 50, and the gain control information-detecting unit 51 is operable to output and detect the gain control information 52. Pursuant to the present embodiment, the gain control information 52 may be, e.g., a signal-to-noise ratio (hereinafter called an “S/N ratio”) detected by the demodulating unit 7 because the S/N ratio is a proper piece of information to recognize a status of each of the signals. Pursuant to the present embodiment, any one of the receiver branches, which has the maximum S/N ratio, is selected to determine the gain control information 52 to allow the amplified signal output from the selected receiver branch to be of a level within the dynamic range. In all of the receiver branches, the signals are amplified in accordance with the determined gain control information 52.

The following discusses a flow of processing when the S/N ratio is used as the gain control information 52.

The gain control information-detecting unit 51 calculates S/N ratios in all of the receiver branches for each unit time in accordance with results from processing at the demodulating unit 7. The maximum S/N ratio is selected from all of the calculated S/N ratios in all of the receiver branches. The selected maximum S/N ratio establishes gains for all of the receiver branches.

The maximum S/N ratio is renewed and selected at any time in accordance with receiver circumstances. When the receiver circumstances are varied quickly, then the S/N ratios are calculated at shorter unit time to renew the maximum S/N ratio quicker.

The gain control information 52 may alternatively be a bit error rate (hereinafter called a “BER”) instead of the S/N ratio.

As illustrated in FIG. 10, a variable amplifier 81 connected to the analog-digital converter 6 at the input thereof may be used as an alternative to amplify the signals to be fed into the analog-to-digital converter 6.

FIG. 10 is a block diagram illustrating the receiver according to the present embodiment. The variable amplifier 81 is provided at the rear of the switch 5.

Similarly to the amplification using the amplifier 61 and variable resistance 62 in each of the sample-and-hold circuits 4, S/N ratio- or BER-based gain control is executed. The gain control using the variable amplifier 81 allows for similar signal processing that meets the dynamic range of the analog-to-digital converter 6.

The receiver as described above never overflows beyond the dynamic range of the analog-to-digital converter 6, even when influences such as fading or interference waves objectionably vary receiver signal strength for each of the receiver branches, and consequently there is a reduced likelihood of errors in quantization in the analog-to-digital converter. The receiver is operable to fully utilize the dynamic range, and provides improved accuracy in quantization. As a result, the signals are received with improved accuracy.

In the receiver, the low-frequency base band signals converted from the high-frequency signals are fed into the switch 5, and, as a matter of course, no signal leak occurs in the switch, and the signals are received with improved accuracy. In addition, the receiver prevents degradation in accuracy to receive the signals, which otherwise would occur as a result of different wiring lengths in layout.

### Third Embodiment

A receiver according to a third embodiment is now described. The present embodiment is directed to sampling clock frequency control in frequency division multiplexing communication.

FIG. 11 is a block diagram illustrating the receiver according to the present embodiment. A clock control unit 101 is provided at the input of a clock-generating unit 8. The clock control unit 101 is operable to control the frequency of each clock generated by the clock-generating unit 8.

In the clock control unit 101, a frequency division multiplexed signal, e.g., is divided into operative and inoperative channels, depending upon how the signal is used.

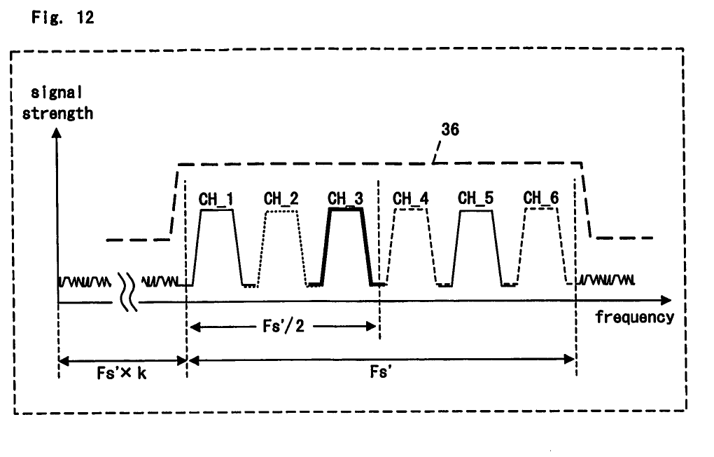

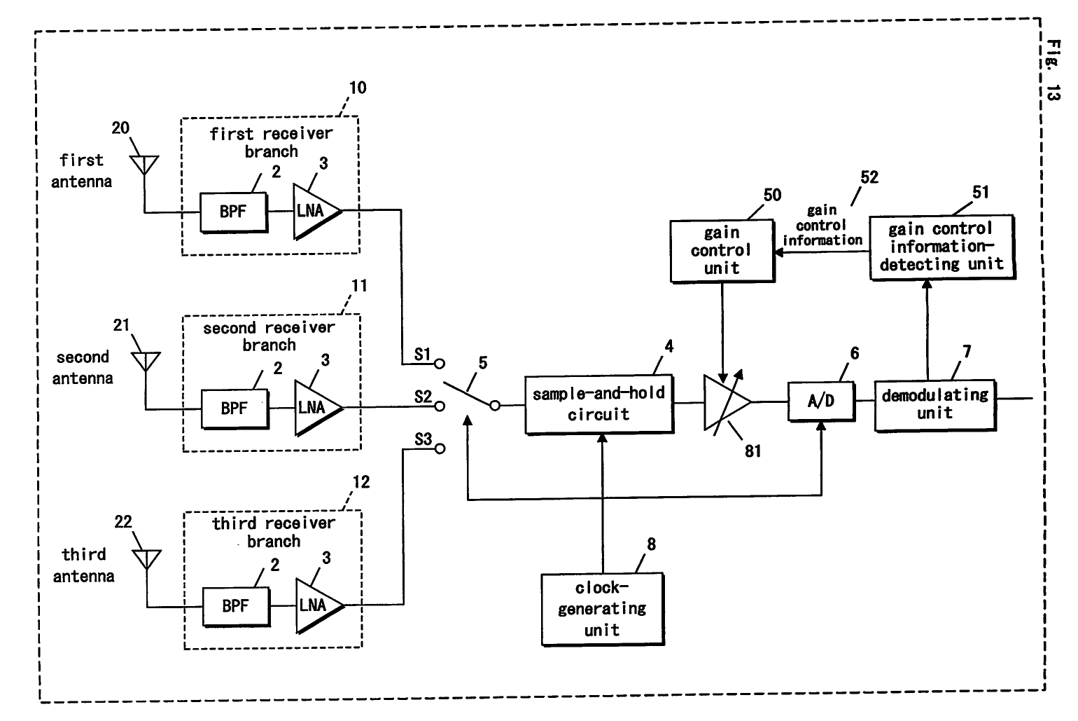

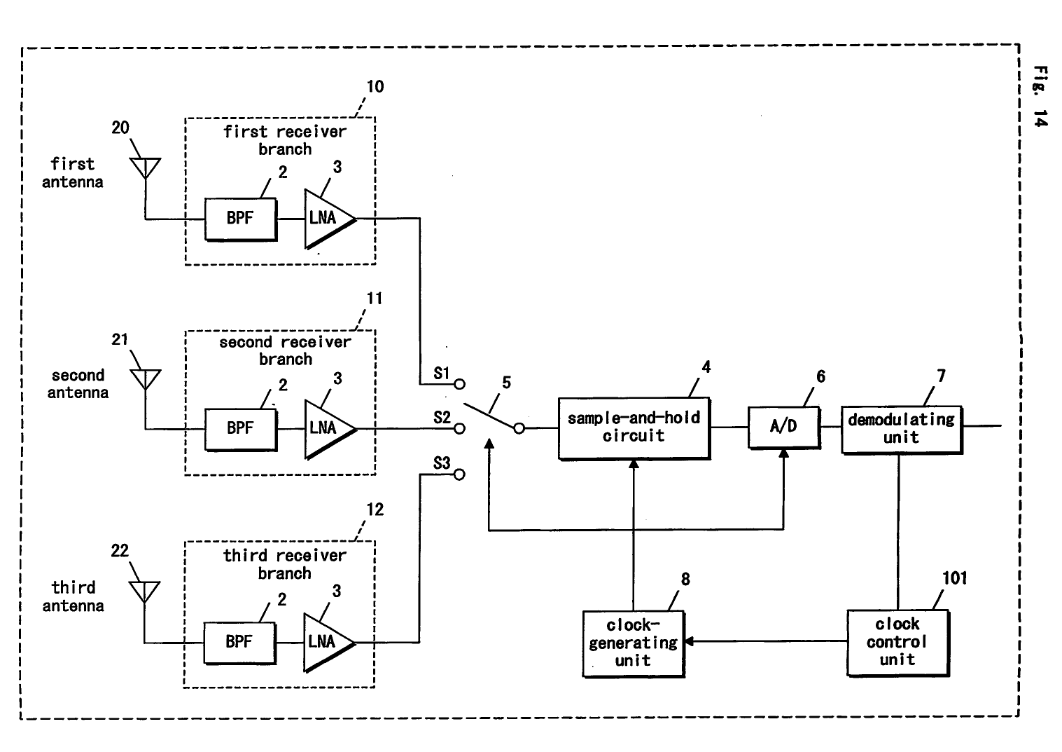

FIG. 12 is an illustration showing a waveform that contains six channels. The six channels of CH_1, CH_2, CH_3, CH_4, CH_5, and CH_6 are present on the frequency scale.

According to the present embodiment, CH_1, CH_3, and CH_5 are operative channels that are in use, and the remainder is inoperative channels that are unused.

The band extending from CH_1 to CH_6 is downsampled, and is thereby converted from a high-frequency band to a low-frequency band. At this time, CH_2, CH_4, and CH_6 are the inoperative channels that are unused, and each of them has a signal level of substantially zero. Accordingly, the band that extends CH_1 to CH_6 need not be downsampled entirely from the beginning to the end of the band.

For example, assume that a half of the sampling clock signal frequency that covers the entire band, i.e., Fs'/2 is used. In this instance, CH_4 having the zero level is overlapped with the band CH_1; CH_5 is overlapped with the band CH_2 having the zero level; and CH_6 having the zero level is overlapped with the band CH_3. As a result, the entire band is reduced to one half without the occurrence of interference between the channels. More specifically, even when the band contains several channels multiplexed by frequency division multiplex, the sampling clock signal frequency can be reduced, depending upon the array of the operative channels. (The sampling clock signal frequency in FIG. 12 can be reduced to one half). The reduced frequency provides reduced power consumption.

The clock control unit 101 is possible to detect any operative channel in accordance with results from demodulation in the demodulating unit 7. For example, the operative channels are detectable on the basis of results from the calculation of electric power for each of the channels in the demodulating unit 7 or otherwise on the basis of an SIN ratio for each of the channels in the demodulating unit 7.

The clock control unit 101 has control of the sampling clock signal frequency based on the array of the detected operative channels. The clock frequency is, of course, changed at any time with a change in either array or number of the operative channels.

As described above, in the frequency division multiplexing communication, the sampling clock signal frequency is controlled based on the array of the operative channels, and a proper reduction in power consumption is achievable.

### Fourth Embodiment

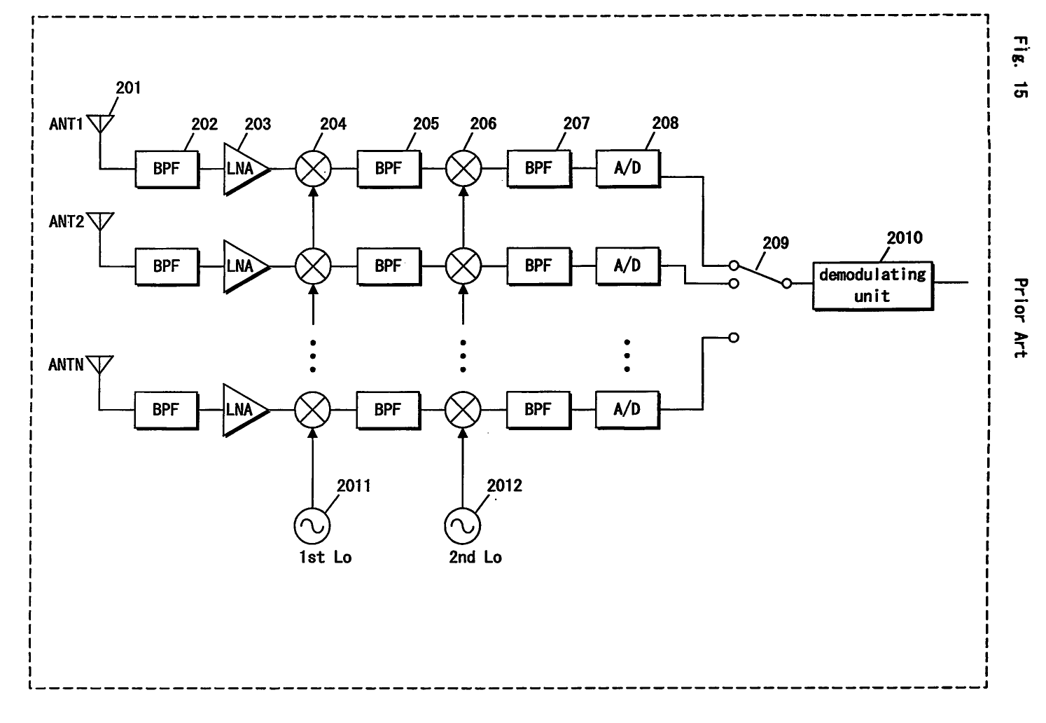

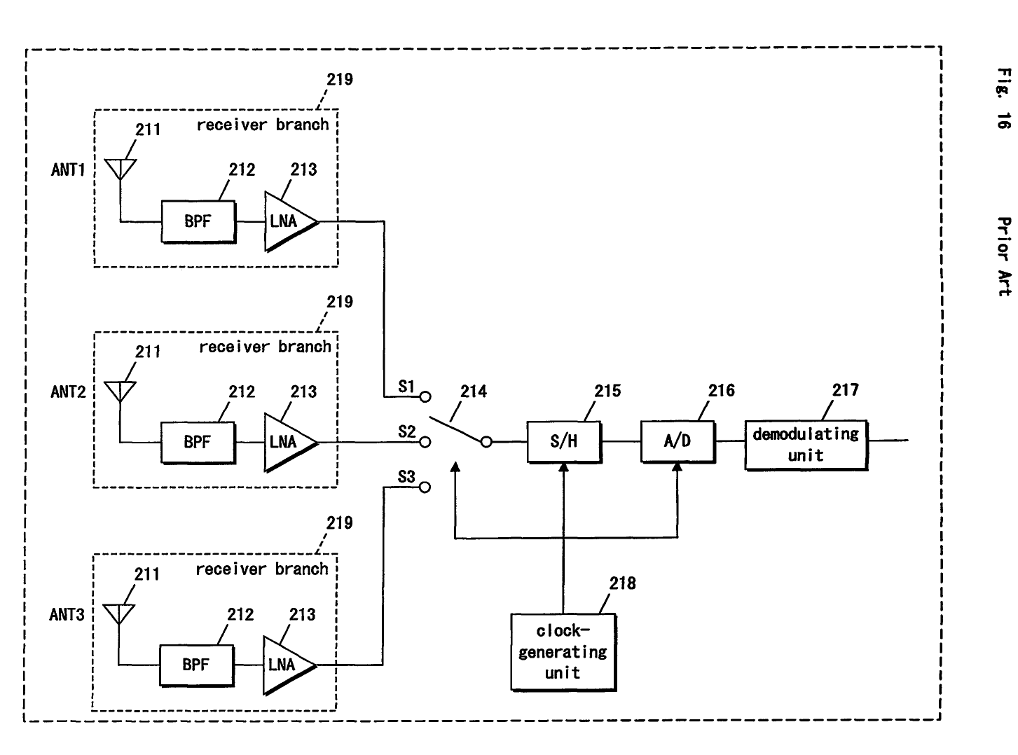

A fourth embodiment is described with reference to FIG. 13 and FIG. 14.

Each of FIG. 13 and FIG. 14 is a block diagram illustrating a receiver according to the present embodiment. In each of the receivers according to the present embodiment, a single sample-and-hold circuit 4 is connected to the conventional switch 5 at the rear thereof. Referring to FIG. 13, the receiver is shown provided with an element operable to control the input to be fed into an analog-to-digital converter 6. Similarly, referring to FIG. 14, a clock control element is shown provided in the prior art receiver.

The receiver as illustrated in FIG. 13 includes elements as given below. Several receiver branches (a first branch 10, a second branch 11, and a third branch 12) are operable to receive signals. When the receiver is assumed to provide wireless communication, each of the receiver branches has an antenna disposed thereon. The antennas are provided according to the number of the receiver branches (three antennas according to the present embodiment). When the receiver is assumed to provide cable communication, a communication connector is attached to each of the receiver branches.

The receiver branches are connected at the outputs thereof to the switch 5 to allow output signals from the receiver branches to enter the switch 5. The switch 5 is operable to selectively feed the output signals from the receiver branches out of the switch 5 at time intervals. The outputs from the switch 5 are fed into the sample-and-hold circuit 4, in which discrete values are extracted from the output signals from the switch 5. A variable amplifier 81 is operable to amplify the output signals from the sample-and-hold circuit 4. The variable amplifier 81 is gain-controlled by a gain control unit 50. Gain control information 52 for use in the gain control is detected by a gain control information-detecting unit 51. The gain control information 52 may be an S/N ratio or otherwise BER, both of which are calculated in a demodulating unit 7.

The amplification in the variable amplifier 81 is controlled to fall within a dynamic range of an analog-to-digital converter 6.

The output signals from the variable amplifier 81 enter the analog-to-digital converter 6, in which the signals are converted in value from analog values to digital values. In the demodulating unit 7, data is demodulated from the signals having the converted digital values.

Each of the receiver branches includes a BPF 2 and a LNA 3.

The above-described receiver prevents the occurrence of errors in quantization in the analog-to-digital converter 6, and receives the signals with improved accuracy.

The receiver as illustrated in FIG. 14 includes elements as given below. Several receiver branches (a first branch 10, a second branch 11, and a third branch 12) are operable to receive signals. When the receiver is assumed to provide wireless communication, each of the receiver branches has an antenna disposed thereon. The antennas are provided according to the number of the receiver branches (three antennas according to the present embodiment). When the receiver is assumed to provide cable communication, a communication connector is attached to each of the receiver branches.

The receiver branches are connected at outputs thereof to a switch 5 to allow output signals from the receiver branches to enter the switch 5. The switch 5 is operable to selectively feed the output signals from the receiver branches out of the switch 5 at time intervals. The outputs from the switch 5 are fed into a sample-and-hold circuit 4, in which discrete values are extracted from the output signals from the switch 5.

The output signals from the sample-and-hold circuit 4 enter the analog-to-digital converter 6, in which the output signals from the sample-and-hold circuit 4 are converted in value from analog values to digital values. In a demodulating unit 7, data is demodulated from the signals having the converted digital values.

A clock-generating unit 8 is operable to generate clock signals, and to feed the generated clock signals into the switch 5, the sample-and-hold circuit 4, and the analog-to-digital converter 6. A clock control unit 101 is operable to control the frequency of each of the clock signals generated by the clock-generating unit 8. For example, to treat a frequency division multiplexed signal, the clock control unit 101 executes clock signal frequency-reducing control in accordance with the array of operative channels.

Similarly to the receivers as previously described with reference to FIG. 11 and FIG. 12, the receivers according to the present embodiment execute clock frequency control, thereby consuming less power.

The receivers according to the first to fourth embodiments may include a transmission capability.

In each of the receivers according to the present invention, the sample-and-hold circuits are provided at the front of the switch, and the low-frequency signals, not the high-frequency signals, are allowed to enter the switch. As a result, neither signal leak nor signal propagation occurs in the switch, and the signals are received with improved accuracy.

Each of the receivers according to the present invention has fewer constraints on design to establish switch isolation, and is available at less cost.

In each of the receivers according to the present invention, the signals to be fed into the analog-to-digital converter are amplified in a controllable manner to lie within the dynamic range of the analog-to-digital converter. As a result, the occurrence of errors in quantization is prevented, and the signals are received with improved accuracy.

Each of the receivers according to the present invention has control of the sampling clock signal frequency in accordance with the array of the operative channels among several channels in the frequency division multiplex, and consequently a reduction in power consumption is achievable.

### INDUSTRIAL APPLICABILITY

The receiver according to the present invention is preferably applicable in the field of, e.g., a receiver adapted for the demodulation based on downsampling-based frequency conversion and the field related thereto.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A receiver comprising:
a plurality of receiver branches operable to receive signals;
a plurality of sample-and-hold circuits, each of which is connected to corresponding one of said plurality of receiver branches, each of said plurality of sample-and-hold circuits being operable to extract a discrete value from an output signal from corresponding one of said plurality of receiver branches;
a switch connected to said plurality of sample-and-hold circuits, said switch being operable to allow output signals from said plurality of sample-and-hold circuits to be selectively fed out of said switch at time intervals; and
a demodulating unit connected to said switch, said demodulating unit being operable to demodulate data from output signals from said switch.

2. A receiver as defined in claim 1, wherein each of said receiver branches includes a band pass filter operable to allow corresponding one of the signals to travel through a certain band, and a first amplifier operable to amplify an output signal from said band pass filter.

3. A receiver as defined in claim 2, wherein each of said receiver branches includes an antenna.

4. A receiver as defined in claim 1, further comprising:
an analog-to-digital converter connected between said switch and said demodulating unit, said analog-to-digital converter being operable to convert the output signals from said switch in value from analog values to digital values.

5. A receiver as defined in claim 4, further comprising:
a clock-generating unit operable to generate clock signals to be fed into said plurality of sample-and-hold circuits, said switch, and said analog-to-digital converter.

6. A receiver as defined in claim 5, further comprising:
an amplifier connected to said clock-generating unit, said amplifier being operable to amplify the clock signals from said clock-generating unit by an integer multiple comparable in number to said plurality of receiver branches,
wherein an output from said amplifier is fed into said switch and said analog-to-digital converter.

7. A receiver as defined in claim 4, further comprising:
a second amplifier connected to said analog-to-digital converter at an input of said analog-to-digital converter;
a gain control unit operable to control a gain in said second amplifier; and
a gain control information-detecting unit operable to detect gain control information to be fed into said gain control unit.

8. A receiver as defined in claim 7, wherein said gain control information is a signal-to-noise ratio (hereinafter called an “S/N ratio”) detected by said demodulating unit.

9. A receiver as defined in claim 7, wherein said gain control information is a bit error rate (hereinafter called a “BER”) detected by said demodulating unit.

10. A receiver as defined in claim 7, wherein said second amplifier has an amplification degree within a dynamic range of said analog-to-digital converter.

11. A receiver as defined in claim 4, further comprising:
a plurality of third amplifiers, each of which is connected to corresponding one of said plurality of sample-and-hold circuits, each of said plurality of third amplifiers being operable to amplify an output from corresponding one of said plurality of sample-and-hold circuits;
a gain control unit operable to control gains in said plurality of third amplifiers; and
a gain control information-detecting unit operable to detect gain control information to be fed into said gain control unit.

12. A receiver as defined in claim 11, wherein each of said plurality of third amplifiers has a substantially identical gain characteristic.

13. A receiver as defined in claim 12, wherein each of said plurality of third amplifiers has an amplification degree, whereby a highest gain possessed by one of output signals from said plurality of sample-and-hold circuits to be amplified by said plurality of third amplifiers falls within a dynamic range of said analog-to-digital converter.

14. A receiver as defined in claim 5, further comprising:
a clock control unit operable to control a clock frequency in said clock-generating unit.

15. A receiver as defined in claim 14, wherein said clock control unit is operable to divide the clock frequency in said clock-generating unit in accordance with a number of frequency division multiplex signals in operative use when the signals received by said plurality of receiver branches include the frequency division multiplex signals.

16. A receiver as defined in claim 1, wherein a length of wiring extending from an input end of each of said plurality of receiver branches to each of said sample-and-hold circuits is substantially identical for each of said plurality of receiver branches.

17. A receiver as defined in claim 1, wherein a load of wiring extending from an input end of each of said plurality of receiver branches to each of said sample-and-hold circuits is substantially identical for each of said plurality of receiver branches.

18. A receiver comprising:
a plurality of receiver branches operable to receive signals;
a switch connected to said plurality of receiver branches, said switch being operable to allow output signals from said plurality of receiver branches to be selectively fed out of said switch at time intervals;
a sample-and-hold circuit connected to said switch, said sample-and-hold circuit being operable to extract discrete values from output signals from said switch;
a variable amplifier connected to said sample-and-hold circuit, said variable amplifier being operable to amplify output signals from said sample-and-hold circuit;
a gain control unit operable to control a gain in said variable amplifier;
a gain control information-detecting unit operable to detect gain control information to be fed into said gain control unit;
an analog-to-digital converter connected to said variable amplifier, said analog-to-digital converter being operable to convert output signals from said variable amplifier in value from analog values to digital values; and
a demodulating unit connected to said analog-to-digital converter, said demodulating unit being operable to demodulate data from output signals from said analog-to-digital converter,
wherein said gain control unit executes control such that the output signals from said variable amplifier fall within a dynamic range of said analog-to-digital converter.

19. A receiver comprising:
a plurality of receiver branches operable to receive signals;
a switch connected to said plurality of receiver branches, said switch being operable to allow output signals from said plurality of receiver branches to be selectively fed out of said switch at time intervals;
a sample-and-hold circuit connected to said switch, said sample-and-hold circuit being operable to extract discrete values from output signals from said switch;
an analog-to-digital converter connected to said sample-and-hold circuit, said analog-to-digital converter being operable to convert output signals from said sample-and-hold circuit in value from analog values to digital values;
a demodulating unit connected to said analog-to-digital converter, said demodulating unit being operable to demodulate data from output signals from said analog-to-digital converter;
a clock-generating unit operable to generate clock signals to be fed into said switch, said sample-and-hold circuit, and said analog-to-digital converter; and
a clock control unit operable to control a clock frequency in said clock-generating unit.
